(19) United States
(12) Patent Application Publication
(10) Pub. No.: US 2002/0123444 A1
(43) Pub. Date: Sep. 5, 2002

(54) Cleaning products

(76) Inventors: Wayne Robert Fisher, Cincinnati, OH (US); Gregory Martin Gressel, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/992,358

(22) Filed: Nov. 14, 2001

(30) Foreign Application Priority Data
Nov. 17, 2000 (GB) 0028192.3

(51) Int. Cl. C11D 17/00

(52) U.S. Cl. 510/297

(57) ABSTRACT

The present invention relates to a container comprising one or more sheets of pouches which are water-soluble, typically the sheet as a whole being water-soluble, the pouches comprising compositions to be delivered to water, typically cleaning compositions and/or fabric enhancing compositions. This provides an easy, efficient and cheap way to pack the pouches in orderly manner and moreover, by immobilizing the pouches in this manner, the pouches are protected against physical forces, without the need of expensive, complex packaging to protect the pouches.

### CROSS REFERENCE TO RELATED APPLICATIONS

This application claims priority under 35 U.S.C. § 119(A) to Great Britain Application Serial No. 0028192.3, filed Nov. 17, 2000 (Attorney Docket No. CM2451F).

### FIELD OF THE INVENTION

This invention relates a container comprising one or more sheets of water-soluble pouches, the pouches comprising a composition to be delivered to water, preferably a cleaning product or a fabric enhancing product. This provides an efficient and effective way of packing the pouches in a container in an orderly manner and protecting them from physical forces.

### BACKGROUND OF THE INVENTION

Cleaning products and fabric care products can be found on the market in various forms, such as granular compositions, liquid compositions and unit dose tablets. Also water-soluble unit dose sachets or pouches have been developed. For example, it is known to make unit dose laundry or dish washing pouches of water-soluble film materials.

A problem with water-soluble pouches is that they are sensitive to atmospheric moisture, resulting in weakening of the pouch material. On the other hands, depending on the conditions, exposure to air can also dry out the pouches, resulting in brittle pouches. Another problem associated with unit dose pouches is that the pouches can rupture during handling or transport, resulting in leaking of the product from the pouch. This is even more problematic if the pouches have been exposed to atmospheric moisture, or if the pouches have become brittle. This not only makes the leaking pouch useless for the consumer, the leaking product can also damage the other pouches. To protect unit dose tablets or pouches, they are often wrapped individually by plastic and/or placed on trays and packed into bags or boxes.

The inventors have now found a new, more convenient way to pack water-soluble pouches, not requiring difficult or extra process steps and not requiring complicated or expensive packaging material. They found that the rupture problem can be reduced or eliminated when the pouches are attached to one another, such that they have the form of a sheet of pouches, and then placing one or more of these sheets into a container. The (adjacent) pouches are hereby substantially immobilised. Physical forces have a reduced negative impact on these sheets of pouches. The mechanical contact between the pouches and the friction between the pouches is reduced; the stress on the weaker part of the pouch, for example the seals, is reduced. To make the packaging method even more efficient, the pouches can be made by a method which results in the formation of a sheet of pouches, which can then be put directly into a container. The sheet of pouches has been found to be more robust then separate pouches. For example, a reduced amount damaged (leaking, deformed) pouches is found after transportation.

The sheets can have lines of weakness around one or more of the pouches, to facilitate the use thereof, e.g. so that the consumer can easily detach (pop out; tear off) one or more pouches, depending on how many are required. The sheet can also or alternatively have visible lines around one or more of the pouches, as to indicate to the user which pouches and/or how many pouches are to be detached (cut off, tear off).

### SUMMARY OF THE INVENTION

The present invention relates to a container comprising one or more sheets of water-soluble pouches, the pouches comprising a composition to be delivered to water, preferably a personal care, (personal) cleaning composition, wash additives such as fabric enhancing or fabric care composition, preferably a laundry detergent composition, dish washing detergent composition, hard-surface cleaning composition or fabric enhancing composition.

Typically, the sheet as a whole is water-soluble. Typically, the sheet and the pouches are made of the same material.

The user can detach one or more of the pouches from the sheet by any means, for example by cutting. However, the sheet or sheets preferably comprises visible lines, so the user knows which or how many pouch or pouches to detach, and/or lines of weakness around the pouches or part thereof, preferably perforations, to help the user to detach the pouch or pouches.

The container is preferably rigid, preferably a rigid box. The container preferably comprises a non-water-soluble bag, the sheet or sheets of pouches being inside said bag and/or the container preferably comprises a reclosable sealing means. This further improved the stability of the pouches, by protecting them against moisture and/or drying out.

The invention also relates to processes for making a container comprising said sheet or sheets of pouches.

The invention also relates to a method of packing water-soluble pouches in a container by providing the pouches in the form of a sheet comprising said pouches, preferably the sheet and the pouches being of the same material, preferably the sheet having visible lines or lines of weakness around one or more of the pouches.

### DETAILED DESCRIPTION OF THE INVENTION

Sheet of pouches

The container comprises one or more sheets of pouches. The part of the sheet excluding the pouches is herein referred to as ‘the remaining sheet’; the pouches are connected to another by this structure.

The sheet comprises at least two pouches, but typically a larger number. The exact number of pouches depends on the surface area of the sheet and the size of the pouches and the size desirable for the container. The sheet may be such that is a string of pouches. Preferred however may be that the sheet has rows of pouches in two dimensions, for example 2×3, 3×3, 3×4, 4×4, 4×5, 5×5, 5×6 6×6 etc.

Preferred is that the distance between adjacent pouches is relatively small, for example it is preferred that the distance between the pouches is less than 50%, preferably less than 40% or even less than 30% of the width or diameter of a pouch.

The remaining sheet can be formed from any material. The remaining sheet is then generally formed first and has recess areas in the shape of the pouches. Then the pouches are placed into these recess areas, such that they do not detach from the sheet under gravity forces, but only when additional physical forces are used, for example when the user pushes the pouch out of the recess area (‘pop out’).

The remaining sheet is preferably also water-soluble and thus, it is preferred that the sheet as a whole is water-soluble. The remaining sheet and the pouches are preferably made of the same material. Preferred is that the sheet as a whole is made of one or more films of water-soluble material. Preferred is that the sheet is made by a process involving shaping from one or more water-soluble films a series of open pouches which are attached to another, then filling these open pouches and closing the open pouches.

Preferably the sheet is obtainable by a process having the steps of placing a water-soluble film over a number of molds, shaping the film into a number of open pouches in said molds, filling the pouches with the composition and closing the open pouches by any method. Thereby, the sheet as a whole is formed from said film or films. This is thus en especially advantage way to produce the sheet in a minimum of process steps, whereby no additional materials are needed to immobilize the pouches.

Optionally, additional pouches may be placed on top of the open pouches, to close the pouches, to thus obtain multi-compartment pouches, or additional pouches may be placed on top of the closed pouches in the sheet.

Preferred ways of shaping the sheet of pouches is described hereinafter in more detail.

Preferred is that the sheet has visible lines around one or more of the pouches, or part thereof. It may even be more preferred that he sheet has lines of weakness, preferably visible lines of weakness around one or more of the pouches, or part thereof. For example, when the user is to use one pouch per operation (e.g. cleaning), each pouch may be surrounded by such lines. Of course, preferably the pouches on the edges of the sheet do not need to have such lines on the side of the pouch which forms the edge of the sheet, but only on the other sides of the pouch, adjacent to other pouches. For example, a pouch on the corner of the sheet typically has only such lines on two sides.

It may also be preferred that the different lines are present in different areas. For example, if the consumer is to use two pouches per use, the lines may be such to indicate this. It may also be preferred that double lines of weakness surround for example two pouches and single lines surrounds each pouch, so detaching two pouches is easier or is clearly indicated to be more preferred than one.

The visible lines are preferably colored lines, embossed lines, or of course they can be visible lines of weakness. The lines can also be cuts through the sheet, which are such that the pouches do not fall out of the remaining sheet under the force of gravity, but allow the user to push out the pouches easily (pop out).

When no lines of weakness are present, the visible lines indicate to the user where to detach the pouch or pouches, for example by cutting.

The lines of weakness are areas where the sheet between pouches is weak when stress or strain is applied, resulting in detachment of at least one pouch. Preferred lines of weakness are lines where the film is thinner, or even more preferably perforations. The user can then simply detaches the pouch or pouches along the lines of weakness.

It may be preferred that both a visible colored or embossed line and a line of weakness are present.

The present invention is in particular useful if the pouches have an area of weakness (not being the lines of weakness around the pouch). Namely, those areas are most likely to rupture is not packed according to the invention. The pouches in the sheet herein may thus have at least an area of weakness, for example the seal or an area where the pouch is thinner and/or stretched, as described herein after.

As said above, the sheets can have any size or shape. The may about the size of the surface area of the box, so the fit in the container for example horizontally. The sheet may also be larger than the surface area of the box, so that the sheet needs to be folded to fit in the box, for example the sheets can be such that the are folded ones even twice or more, to form a zigzag structure in the box.

Preferred is that the sheets of pouches have about the same size and preferably about the same shape. It may be preferred hat they are placed on one another in the container such that they overlap almost completely or even completely. Then, the centers of each pouch of one sheet are preferably positioned exactly on top of each center of the pouches in another sheet.

The sheet may comprise pouches of different shape and/or comprising a different composition. Then, typically two or more different pouches are to be used per operation (e.g. cleaning). It may also be preferred that the container comprises more than one sheet and that the pouches in one sheet differ in shape or differ in composition (contained inside said pouch) compared to the pouches in another sheet, and/or that different sheets differ in material used to form the sheet (e.g. different film material). Then, typically two or more different pouches of different sheets are to be used per operation (e.g. cleaning).

Pouches

The pouches herein are typically closed structures, made of a water-soluble material or preferably film described herein, enclosing a volume space which comprises a composition. Said composition is described in more detail hereinafter. The pouch can be of any form, shape and material which is suitable to hold the composition, e.g. without allowing the release of the composition from the pouch prior to contact of the pouch to water. The exact execution will depend on for example, the type and amount of the composition in the pouch, the number of compartments in the pouch, the characteristics required from the pouch to hold, protect and deliver or release the compositions.

The pouch may have one compartment, holding a solid or in certain executions preferably liquid composition, or it may have a number of compartment, attached to one another, or having one compartment enclosing (but not attached to) one or more other compartments.

The pouch may be of such a size that it conveniently contains either a unit dose amount of the composition herein, suitable for the required operation, for example one wash, or only a partial dose, to allow the consumer greater flexibility to vary the amount used, for example depending on the size and/or degree of soiling of the wash load. The pouches are typically of a size having the largest cross-sectional distance of from 1 cm to 50 cm, preferably from 2 cm to 10 cm. The pouches are preferably of such a size that each can comprises a volume of from 1 ml to 200 ml, preferably from 10 ml to 60 ml. It may be preferred that the water soluble film is stretched during formation and/or closing of the pouch, such that the resulting pouch is at least partially in stretched state. This is for example useful to reduce the amount of film required to enclose the volume space of the pouch. When the film is stretched the film thickness generally decreases. The degree of stretching can thus indicate the amount of stretching of the film by the reduction in the thickness of the film. For example, if by stretching the film, the thickness of the film is exactly halved then the stretch degree of the stretched film is 100%. Also, if the film is stretched so that the film thickness of the stretched film is exactly a quarter of the thickness of the unstretched film then the stretch degree is exactly 200%. Typically and preferably, the thickness and hence the degree of stretching is non-uniform over the pouch, due to the formation and closing process.

Another advantage of using stretching the pouch, is that the stretching action, when forming the shape of the pouch and/or when closing the pouch, stretches the pouch non-uniformly, which results in a pouch which has a non-uniform thickness. This allows control of the dissolution of water-soluble pouches herein, and for example sequential release of the components of the detergent composition enclosed by the pouch to the water.

Preferably, the pouch is stretched such that the thickness variation in the pouch formed of the stretched water-soluble film is from 10 to 1000%, preferably 20% to 600%, or even 40% to 500% or even 60% to 400%. This can be measured by any method, for example by use of an appropriate micrometer. Preferably the pouch is made from a water-soluble film that is stretched, said film has a stretch degree of from 40% to 500%, preferably from 40% to 200%.

Preferably, the pouch and film used has an unstretched thickness of from 50 micrometers to 200 micrometers, preferably from 60 micrometers, or from 70 micrometers, and preferably to 150 micrometers, or to 100 micrometers, or to 90 micrometers, or to 80 micrometers. Preferred may be that the pouches of the sheet herein are made of a film which is stretched and has, at least in the part which is stretched, a thickness of less than 100 microns, or even less than 80 microns, preferably even less than 70 microns or even less than 50 microns or even less than 35 microns.

Preferred may be that the sheet of pouches is made using a series of molds having the same shape. The molds are preferably positioned in an interlocking, adjacent manner. The molds are preferably evenly spaced apart.

Preferably the shape of the mold is circular, no having any corners or s shape having no corners of an internal angle of less than about 90°. Preferred are round, hexagon, square, rectangle, rhombus, shapes. The bottom of the mold is preferably rounded, the indent of the mold is preferably hemispherical-like. This is to minimize the variation of stretch introduced to a film which is pulled flush to the inner surface of the mold. The pouch preferably contains different compartments. Preferably, the different compartments comprise different compositions and/or preferably the compartments are visibly distinct, for example the compartments (or compositions) having a different color, shape and/or size, or comprising compositions with visibly different properties, for example physical states (liquid and solid), different density, viscosity, color, or mixtures thereof. Preferred may be that one compartment comprises a solid composition and another compartment a liquid composition. It may be preferred that one compartment comprises a composition of a different viscosity, density, than the composition in the other compartment. Preferred may also be that the compositions or compartments or part thereof have different shades or color, for example white and blue, or comprising speckle particles. Preferred may also be that one composition is a clear liquid and another an opaque liquid. It may also be preferred that one compartment is smaller than another compartment, typically such that the compartment to be opened in the first step is smaller than the other compartment.

Preferred is that when the part of the sheet from the visible lines and/or lines of weakness around a pouch to the edge of said pouch forms a skirt around the pouch when detached. The width of this skirt of frill (i.e. distance from pouch to end of frill or edge) is preferably at least 0.05 mm, more preferably at least 0.1 mm or even 0.2 mm or even at least 0.3 mm or even at least 0.5 mm, and it may typically be up to 3 cm or even up to 2 cm or even up to 1.5 cm.

Water-soluble material or film

The water-material used to make the pouch and preferably the sheets as a whole is preferably in the form of a film. The material or the film has preferably a solubility of at least 50%, preferably at least 75% or even at least 95%, as measured by the gravimetric method set out hereinafter, using a glass-filter with a maximum pore size of 20 microns, namely: Gravimetric method for determining water-solubility or water-solubility of the film: 50 grams±0.1 gram of film is added in a 400 ml beaker, whereof the weight has been determined, and 245 ml±1 ml of distilled water is added. This is stirred vigorously on magnetic stirrer set at 600 rpm, for 30 minutes. Then, the mixture is filtered through a folded qualitative sintered-glass filter with the pore sizes as defined above (max. 20 or 50 micron). The water is dried off from the collected filtrate by any conventional method, and the weight of the remaining polymer is determined (which is the dissolved or dispersed fraction). Then, the % solubility can be calculated.

Preferred water-soluble films are polymeric materials, preferably polymers which are formed into a film or sheet. The material in the form of a film can for example be obtained by casting, blow-molding, extrusion or blow extrusion of the polymer material, as known in the art.

Preferred polymers, copolymers, or derivatives thereof, are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum.

More preferably the polymer is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, most preferably polyvinyl alcohols, polyvinyl alcohol copolymers and hydroxypropyl methyl cellulose (HPMC).

The polymer can have any weight average molecular weight, preferably from about 1000 to 1,000,000, or even form 10,000 to 300,000 or even form 15,000 to 200,000 or even form 20,000 to 150,000.

Mixtures of polymers can also be used. This may in particular be beneficial to control the mechanical and/or dissolution properties of the film, depending on the application thereof and the required needs. For example, it may be preferred that a mixture of polymers is present in the film, whereby one polymer material has a higher water-solubility than another polymer material, and/or one polymer material has a higher mechanical strength than another polymer material. It may be preferred that a mixture of polymers is used, having different weight average molecular weights, for example a mixture of PVA or a copolymer thereof of a weight average molecular weight of 10,000-40,000, preferably around 20,000, and of PVA or copolymer thereof, with a weight average molecular weight of about 100,000 to 300,000, preferably around 150,000.

Also useful are polymer blend compositions, for example comprising hydrolytically degradable and water-soluble polymer blend such as polylactide and polyvinyl alcohol, achieved by the mixing of polylactide and polyvinyl alcohol, typically comprising 1-35% by weight polylactide and approximately from 65% to 99% by weight polyvinyl alcohol, if the material is to be water-dispersible, or water-soluble.

It may be preferred that the polymer present in the film is from 60% to 98% hydrolysed, preferably 80% to 90%, to improve the dissolution of the material.

Suitable examples of commercially available water-soluble films include polyvinyl alcohol and partially hydrolysed polyvinyl acetate, alginates, cellulose ethers such as carboxymethylcellulose and methylcellulose, polyethylene oxide, polyacrylates and combinations thereof. Most preferred are films which comprises PVA polymers and have similar properties to films that are known under the trade reference M8630, as sold by Chris-Craft Industrial Products of Gary, Ind., US. Other preferred films suitable for use herein have similar properties to films that are known under the trade reference PT film or the K-series of films supplied by Aicello, or VF-HP film supplied by Kuraray.

The film herein may comprise other additive ingredients than the polymer or polymer material. For example, it may be beneficial to add plasticisers, for example glycerol, ethylene glycol, diethyleneglycol, propylene glycol, sorbitol and mixtures thereof, additional water, disintegrating aids. It may be useful when the pouched composition is a detergent composition, that the pouch or compartment material itself comprises a detergent additive to be delivered to the wash water, for example organic polymeric soil release agents, dispersants, dye transfer inhibitors.

Process

The sheet of pouches is preferably obtained by a process involving the steps of forming from one or more water-soluble films open pouches, filling the pouches and closing the pouches, and placing the sheet or sheets in a container.

Preferably, the process involves the step of making one or more sheets of pouches and making visible lines, preferably lines of weakness around the pouches or part thereof, and then placing one or more of the sheets in a container.

Preferably, the process for obtaining a container comprises the steps of placing a film over a series of mold, shaping the film into a series of open pouches in said molds, filling the pouches with the composition, closing the open pouches, applying visible lines or preferably lines of weakness around the pouches or part thereof and placing one or more of the obtained sheet in a container.

The process for preparing the sheet of water-soluble pouches comprises preferably the step of shaping pouches in molds which are positioned in an interlocking manner.

For example, a water soluble film is placed onto and into the molds. A preferred method is thermo-forming to get the film to adopt the shape of the molds. Thermo-forming typically involves the step of formation of an open pouches in molds under application of heat, which allows the film used to make the pouches to take on the shape of the molds. Also preferred is a process of vacuum-forming, which typically involves the step of applying a (partial) vacuum (reduced pressure) on molds which sucks the film into the molds and ensures the film adopts the shape of the molds. This process may also be done by first heating the film and then applying reduced pressure, e.g. (partial) vacuum.

The pouches may be closed by any means, for example by sealing one or more films. For example, by heat sealing, wet sealing or by pressure sealing. In a preferred embodiment, a sealing source is contacted to the film and heat or pressure is applied to the film, and the film is sealed. The sealing source may be a solid object, for example a metal, plastic or wood object. If heat is applied to the film during the sealing process, then said sealing source is typically heated to a temperature of from 40° C. to 200° C. If pressure is applied to the film during the sealing process, then the sealing source typically applies a pressure of from 1×10⁴ Nm⁻² to 1×10⁶ Nm⁻², to the film.

The same piece of film may be folded, and sealed to form pouches. Typically more than piece of film is used in the process herein. For example, a first piece of the water soluble film may be vacuum pulled into the molds so that said film is flush with the inner walls of the molds. A second piece of water-soluble film may be positioned such that it at least partially overlaps, preferably completely overlaps, with the first piece of film. The first piece of film and second piece of film are sealed together. The first piece of film and second piece of film can be the same type of film or can be different types of film.

For example the sheet may be involve: a first piece of the water soluble film is vacuum pulled into the molds so that said film is flush with the inner walls of the molds. A composition is poured into the molds, and a second water-soluble film is placed over the molds with the composition and the first piece of film and second piece of film are sealed together to form the sheet of pouches. This is then placed in the container.

Preferably the first film is stretched, as defined hereinafter. Typically, the second film is not as stretched as the first film.

The process herein may be used to prepare pouches which have an internal volume that is divided into more than one compartment, typically known as a multi-compartment pouches. In this preferred process, the film is folded at least twice, or at least two pieces of film are used wherein at least one piece of film is folded at least once, or at least three pieces of film are used. The third piece of film, or a folded piece of film, creates a barrier layer that, when the pouch is sealed, divides the internal volume of said pouch into at least two compartments.

Also, the process herein can be used to prepare water-soluble multi-compartment pouches by, fitting a first piece of the water soluble film into a series of molds, for example the first piece of film may be vacuum pulled into the molds so that said film is flush with the inner walls of the molds and a composition is poured into the molds. A pre-sealed compartment made of a water-soluble film and comprising also a composition can then be placed over the molds containing the composition. These pre-sealed compartments and said first piece of film may be sealed together to form multi-compartment pouches, for example, dual-compartment pouches.

Container for sheets

Any container suitable for holding and storage of the sheet or sheets of pouches can be used. The container is not water-soluble. Preferred are rigid containers, for example a tub or box. Typically the container has at least one wall, bottom or top which can be partially or completely opened. Preferred is a box having a top lid which can be opened and closed.

Preferably, the container comprises more than one sheet of pouches. Preferred may be that the sheets form layers in the container. Preferred may be that between the layers of sheets, a protective layer is placed, separating the sheets, for example a sheet of plastic or paper.

To further protect the sheets of pouches, in particular against moisture or drying out once the container has been opened, the container may comprise an inner (non-water-soluble) bag, wherein the sheets of pouches are placed. Also, the container is preferably reclosable after first opening. This can be achieved by any means to close a container. It may also be possible to place the container in a bag which is reclosable.

Compositions

Preferred compositions herein are personal care compositions, personal cleaning compositions, hard-surface cleaning compositions, dish-washing detergent compositions, laundry detergent compositions, laundry and dish washing additive compositions such as fabric enhancers, bleach compositions.

Preferably, the composition is a cleaning composition and comprises at least a surfactant. Preferably, it comprises also builders, bleach, enzymes, chelating agents and/or perfumes.

Highly preferred is that the compositions is divided over different compartment and that the compositions differ chemically per compartment.

It may be preferred that the composition (or one of the compositions, if more than one is present) is liquid, including non-aqueous liquids and gels, which is transparent. It may also be preferred that the compositions have a different physical state, for example that a first composition is liquid and a second composition is solid.

If a liquid composition is present, it preferably comprises one or more solvent, preferably from 1% to 60% or even 5% to 50% or even 8% to 40% by weight of the liquid composition. Preferred are organic solvents such as methyl or ethyl or methoxylated or ethoxylated amines, alcohols, polyethylene glycol, glycerol, water and mixtures thereof. Preferred may be that only small amounts of water, up to 20% or even up to 10% or up to 8% or even up to 4% by weight of the liquid composition. Preferably, other solvents are present, such as alcohols, glycerine, polyethylene glycol, paraffin.

Preferred ingredients of the compositions

The preferred surfactants for the compositions herein are selected from anionic, nonionic, cationic, ampholytic, amphoteric and zwitterionic surfactants and mixtures thereof. Preferably the compositions comprise from 5% more preferably from 10%, yet more preferably from 15%, to 80%, more preferably to 50%, yet more preferably to 30% by weight of the composition of surfactant.

Anionic sulfonate surfactants suitable for use herein include the salts of C₅-C₂₀ linear alkylbenzene sulfonates, alkyl ester sulfonates, C₆-C₂₂ primary or secondary alkane sulfonates, C₆-C₂₄ olefin sulfonates, sulfonated polycarboxylic acids, alkyl glycerol sulfonates, fatty acyl glycerol sulfonates, fatty oleyl glycerol sulfonates, and any mixtures thereof.

Anionic sulfate surfactants suitable for use herein include the linear and branched primary and secondary alkyl sulfates, alkyl ethoxysulfates, fatty oleoyl glycerol sulfates, alkyl phenol ethylene oxide ether sulfates, the C₅-C₁₇ acyl-N-(C₁-C₄ alkyl) and -N-(C₁-C₂ hydroxyalkyl) glucamine sulfates, and sulfates of alkylpolysaccharides such as the sulfates of alkylpolyglucoside (the nonionic nonsulfated compounds being described herein).

Alkyl sulfate surfactants are preferably selected from the linear and branched primary C₁₀-C₁₈ alkyl sulfates, more preferably the C₁₁-C₁₅ branched chain alkyl sulfates and the C₁₂-C₁₄ linear chain alkyl sulfates.

Alkyl ethoxysulfate surfactants are preferably selected from the group consisting of the C₁₀-C₁₈ alkyl sulfates which have been ethoxylated with from 0.5 to 20 moles of ethylene oxide per molecule. More preferably, the alkyl ethoxysulfate surfactant is a C₁₁-C₁₈, most preferably C₁₁-C₁₅ alkyl sulfate which has been ethoxylated with from 0.5 to 7, preferably from 1 to 5, moles of ethylene oxide per molecule.

Essentially any alkoxylated nonionic surfactants are suitable herein. The ethoxylated and propoxylated nonionic surfactants are preferred.

Preferred alkoxylated surfactants can be selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ethylene diamine adducts.

The condensation products of aliphatic alcohols with from 1 to 25 moles of alkylene oxide, particularly ethylene oxide and/or propylene oxide, are suitable for use herein. The alkyl chain of the aliphatic alcohol can either be straight or branched, primary or secondary, and generally contains from 6 to 22 carbon atoms. Particularly preferred are the condensation products of alcohols having an alkyl group containing from 8 to 16 carbon atoms.

Highly preferred, in particular such that it is dispensed in step a) at least, are alkoxylated, preferably ethoxylated, cationic monoamines, diamines polyamines. The positive charge of the N+ groups is offset by the appropriate number of counter anions. Suitable counter anions include Cl—, Br—, SO₃₋², PO₄₋², MeOSO₃₋ and the like. Particularly preferred counter anions are Cl— and Br—.

Preferred are cationic amines substituted with one or more polyoxyalkylene moieties —[(R⁶O)ₘ(CH₂CH₂₋Oₙ)—]. The moieties —(R⁶O)ₘ— and —(CH₂CH₂O)n— of the polyoxyalkylene moiety can be mixed together or preferably form blocks of —(R⁶O)ₘ— and —(CH₂CH₂O)ₙ— moieties. R⁶ is preferably C₃H₆ (propylene); m is preferably from 0 to about 5 and is most preferably 0, i.e. the polyoxyalkylene moiety consists entirely of the moiety —(CH₂CH₂O)ₙ—. The moiety —(CH₂CH₂O)ₙ— preferably comprises at least about 85% by weight of the polyoxyalkylene moiety and most preferably 100% by weight (m is O).

Preferred ethoxylated cationic monoamines and diamines have the formula:

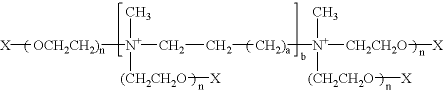

wherein X and n are defined as before, a is from 0 to 20, preferably from 0 to 4 (e.g. ethylene, propylene, hexamethylene), b is 1 or 0. For preferred cationic monoamines (b=0), n is preferably at least about 14, with a typical range of from about 16 to about 35, or even 17 to 25. For preferred cationic diamines (b=1), n is at least about 12 with a typical range of from about 12 to about 42.

The composition herein preferably comprises a bleaching agent, or even a mixture of bleaching agents. Preferably the compositions comprise from 3% more preferably from 5%, yet more preferably from 10%, to 40%, more preferably to 25%, yet more preferably to 20% by weight of the composition of bleaching agent.

Suitable N-acylated lactam perbenzoic acid precursors have the formula:

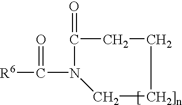

wherein n is from 0 to 8, preferably from 0 to 2, and R⁶ is a benzoyl group.

A preferred class of substituted perbenzoic acid precursor compounds are the amide substituted compounds of the following general formulae:

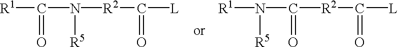

wherein R¹ is an aryl or alkaryl group with from 1 to 14 carbon atoms, R² is an arylene, or alkarylene group containing from 1 to 14 carbon atoms, and R⁵ is H or an alkyl, aryl, or alkaryl group containing 1 to 10 carbon atoms and L can be essentially any leaving group. R¹ preferably contains from 6 to 12 carbon atoms. R² preferably contains from 4 to 8 carbon atoms. R¹ may be aryl, substituted aryl or alkylaryl containing branching, substitution, or both and may be sourced from either synthetic sources or natural sources including for example, tallow fat. Analogous structural variations are permissible for R². The substitution can include alkyl, aryl, halogen, nitrogen, sulphur and other typical substituent groups or organic compounds. R⁵ is preferably H or methyl. R¹ and R⁵ should not contain more than 18 carbon atoms in total. Amide substituted bleach activator compounds of this type are described in EP-A-0170386.

The hydrophobic peroxy acid bleach precursor preferably comprises a compound having a oxy-benzene sulphonate group, preferably nonanoyl oxy-benzene sulphonate (NOBS), decanoyl oxy-benzene sulphonate (DOBS) and/or comprising (6-nonamidocaproyl) oxybenzene sulfonate (NACA-OBS).

Also highly preferred are more hydrophilic peroxy acid bleach precursors or activators such as TAED.

Also preferred bleaching agent for use herein are particulate peracids. In an even more preferred embodiment the peracid is selected from the range of pre-formed mono peroxycarboxylic acid. In an even more preferred embodiment the pre-formed peracid is phthaloyl amido peroxyhexanoic acid, known as PAP.

The bleach activator or precursor and/or the pre-formed peracid is preferably used in particulate form, or as a particle, suspended in a liquid matrix. The liquid matrix where present is substantially non-aqueous meaning that it does not comprise a level of water that would result in the dissolution of the bleach precursor or peracid. Preferred suspending agent used to suspend the bleach activator or precursor, or the peracid are solvents which do not either dissolve or damage the pouches. More preferably the suspending agent is a long chain, low polarity solvent. By long chain it is meant solvents comprising a carbon chain of greater than 6 carbon atoms and by low polarity it is meant a solvent having a dielectric constant of less than 40. Preferred solvents include C12-14 paraffin and more preferably C12-14 isoparaffin.

Examples of inorganic perhydrate salts include perborate, percarbonate, perphosphate, persulfate and persilicate salts. The inorganic perhydrate salts are normally the alkali metal salts. The inorganic perhydrate salt may be included as the crystalline solid without additional protection. For certain perhydrate salts however, the preferred executions of such granular compositions utilize a coated form of the material which provides better storage stability for the perhydrate salt in the granular product. Suitable coatings comprise inorganic salts such as alkali metal silicate, carbonate or borate salts or mixtures thereof, or organic materials such as waxes, oils, or fatty soaps.

Sodium perborate (a perhydrate salt in the form of the monohydrate of nominal formula NaBO₂H₂O₂ or the tetrahydrate NaBO₂H₂O₂.3H₂O), may be used, but is not compatible with certain pouch materials with -OH groups, such as PVA, and is thus often not preferred.

Alkali metal percarbonates, particularly sodium percarbonate are preferred perhydrates herein. Sodium percarbonate is an addition compound having a formula corresponding to 2Na₂CO₃.3H₂O₂, and is available commercially as a crystalline solid.

Chloride bleaches may also be useful, in particle when the article is a bleach additive or hard surface cleaner. Suitable bleaches are hypochlorite species in aqueous solution include alkali metal and alkaline earth metal hypochlorites, hypochlorite addition products, chloramines, chlorimines, chloramides, and chlorimides. Specific examples of compounds of this type include sodium hypochlorite, potassium hypochlorite, monobasic calcium hypochlorite, dibasic magnesium hypochlorite, chlorinated trisodium phosphate dodecahydrate, potassium dichloroisocyanurate, sodium dichloroisocyanurate sodium dichloroisocyanurate dihydrate, trichlorocyanuric acid, 1,3-dichloro-5,5-dimethylhydantoin, N-chlorosulfamide, Chloramine T, Dichloramine T, chloramine B and Dichloramine B. A preferred bleaching agent is sodium hypochlorite, potassium hypochlorite, or a mixture thereof.. A preferred chlorine-based bleach can be Triclosan (trade name).

A preferred ingredients of the liquid compositions herein are opacifying agents and. or dyes, to dye the liquid composition, and dyed particles or speckles for solid compositions herein. The dye as used herein can be a dye stuff or an aqueous or nonaqueous solution of a dye stuff. It may be preferred that the dye is an aqueous solution comprising a dyestuff at any level, to add to liquid compositions or to obtain dyed particles by applying the solution onto granules, preferably such that levels of dye are obtained up to 5%, or even up to 2% by weight of a composition. The dye may also be mixed with a non-aqueous carrier material or organic binder materials, which may also be a non-aqueous liquid.

The dyestuff can be any suitable dyestuff. Specific examples of suitable dyestuffs include E104-food yellow 13 (quinoline yellow), E110-food yellow 3 (sunset yellow FCF), E131- food blue 5 (patent blue V), Ultra Marine blue (trade name), E133-food blue 2 (brilliant blue FCF), E140-natural green 3 (chlorophyll and chlorphyllins), E141 and Pigment green 7 (chlorinated Cu phthalocyanine). Preferred dyestuffs may be Monastral Blue BV paste (trade name) and/or Pigmasol Green (trade name).

Also useful herein are fabric substantive dyes (in contrast to the above dyes which are not fabric substantive), to provide dyeing of fabrics treated with the article of the invention.

Another preferred ingredient of the compositions herein is a perfume oil or perfume composition. Any perfume oil or composition can be used herein. The perfumes may also be encapsulated. Preferred may be that the second pouch comprises the perfume, so that this is delivered a t a later stage, to ensure a more efficient delivery of the perfume to the fabric.

Preferred perfumes containing at least one component with a low molecular weight volatile component, e.g. having a molecular weight of from 150 to 450 or preferably 350. Preferably, the perfume component comprises an oxygen-containing functional group. Preferred functional groups are aldehyde, ketone, alcohol or ether functional groups or mixtures thereof.

Preferred aldehydes are selected from citral, 1-decanal, benzaldehyde, florhydral, 2,4-dimethyl-3-cyclohexen-1-carboxaldehyde; cis/trans-3,7-dimethyl-2,6-octadien-1-al; heliotropin; 2,4,6-trimethyl-3-cyclohexene-1-carboxaldehyde; 2,6-nonadienal; alpha-n-amyl cinnamic aldehyde, alpha-n-hexyl cinnamic aldehyde, P.T. Bucinal, lyral, cymal, methyl nonyl acetaldehyde, trans-2-nonenal, lilial, trans-2-nonenal, lauric aldehyde, undecylenic aldehyde, mefloral and mixture thereof.

Preferably, the perfume ketone is selected from buccoxime; iso jasmone; methyl beta naphthyl ketone; musk indanone; tonalid/musk plus; Alpha-Damascone, Beta-Damascone, Delta-Damascone, Iso-Damascone, Damascenone, Damarose, Methyl-Dihydrojasmonate, Menthone, Carvone, Camphor, Fenchone, Alpha-Ionone, Beta-Ionone, Gamma-Methyl so-called Ionone, Fleuramone, Dihydrojasmone, Cis-Jasmone, Iso-E-Super, Methyl-Cedrenyl-ketone or Methyl-Cedrylone, Acetophenone, Methyl-Acetophenone, Para-Methoxy-Acetophenone, Methyl-Beta-Naphtyl-Ketone, Benzyl-Acetone, Benzophenone, Para-Hydroxy-Phenyl-Butanone, Celery Ketone or Livescone, 6-Isopropyldecahydro-2-naphtone, Dimethyl-Octenone, Freskomenthe, 4-(1-Ethoxyvinyl)-3,3,5,5,-tetramethyl-Cyclohexanone, Methyl-Heptenone, 2-(2-(4-Methyl-3-cyclohexen-1-yl)propyl)-cyclopentanone, 1-(p-Menthen-6(2)-yl)-1-propanone, 4-(4-Hydroxy-3-methoxyphenyl)-2-butanone, 2-Acetyl-3,3-Dimethyl-Norbornane, 6,7-Dihydro-1,1,2,3,3-Pentamethyl-4(5H)-Indanone, 4-Damascol, Dulcinyl or Cassione, Gelsone, Hexalon, Isocyclemone E, Methyl Cyclocitrone, Methyl-Lavender-Ketone, Orivon, Para-tertiary-Butyl-Cyclohexanone, Verdone, Delphone, Muscone, Neobutenone, Plicatone, Veloutone, 2,4,4,7-Tetramethyl-oct-6-en-3-one, Tetrameran, hedione, and mixtures thereof.

More preferably, for the above mentioned compounds, the preferred ketones are selected from Alpha Damascone, Delta Damascone, Iso Damascone, Carvone, Gamma-Methyl-Ionone, Iso-E-Super, 2,4,4,7-Tetramethyl-oct-6-en-3-one, Benzyl Acetone, Beta Damascone, Damascenone, methyl dihydrojasmonate, methyl cedrylone, hedione, and mixtures thereof.

Preferred are also perfume compositions comprising perfume oils and a carrier material, for example as described in JP-56075159, describing the combination of methacrylonitrilebutadiene-styrene tertiary polymer with a liquid perfume; GB2141726, DE 3247709; WO 97/34982; WO 94/19449; WO 98/28398. Preferably, the carrier is a water-insoluble polymer, preferably selected from polymers which have chemically reacted with the perfume ingredient, to make the carrier as above mentioned.

Preferably the compositions comprise from 0.05% more preferably from 1%, yet more preferably from 3%, to 15%, more preferably to 10% by weight of the composition of perfume oil or perfume composition.

The compositions herein preferably contain a heavy metal ion sequestrant or chelant or chelating agent. By heavy metal ion sequestrant it is meant herein components which act to sequester (chelate) heavy metal ions. These components may also have calcium and magnesium chelation capacity, but preferentially they show selectivity to binding heavy metal ions such as iron, manganese and copper.

Heavy metal ion sequestrants are generally present at a level of from 0.005% to 10%, preferably from 0.1% to 5%, more preferably from 0.25% to 7.5% and most preferably from 0.3% to 2% by weight of the compositions.

Suitable heavy metal ion sequestrants for use herein include organic phosphonates, such as the amino alkylene poly (alkylene phosphonates), alkali metal ethane 1-hydroxy disphosphonates and nitrilo trimethylene phosphonates.

Preferred among the above species are diethylene triamine penta (methylene phosphonate), ethylene diamine tri (methylene phosphonate) hexamethylene diamine tetra (methylene phosphonate) and hydroxy-ethylene 1,1 diphosphonate, 1,1 hydroxyethane diphosphonic acid and 1,1 hydroxyethane dimethylene phosphonic acid.

Other suitable heavy metal ion sequestrant for use herein include nitrilotriacetic acid and polyaminocarboxylic acids such as ethylenediaminotetracetic acid, ethylenediamine disuccinic acid, ethylenediamine diglutaric acid, 2-hydroxypropylenediamine disuccinic acid or any salts thereof.

Other suitable heavy metal ion sequestrants for use herein are iminodiacetic acid derivatives such as 2-hydroxyethyl diacetic acid or glyceryl imino diacetic acid, described in EP-A-317,542 and EP-A-399,133. The iminodiacetic acid-N-2-hydroxypropyl sulfonic acid and aspartic acid N-carboxymethyl N-2-hydroxypropyl-3-sulfonic acid sequestrants described in EP-A-516,102 are also suitable herein. The β-alanine-N,N′-diacetic acid, aspartic acid-N,N′-diacetic acid, aspartic acid-N-monoacetic acid and iminodisuccinic acid sequestrants described in EP-A-509,382 are also suitable.

EP-A-476,257 describes suitable amino based sequestrants. EP-A-510,331 describes suitable sequestrants derived from collagen, keratin or casein. EP-A-528,859 describes a suitable alkyl iminodiacetic acid sequestrant. Dipicolinic acid and 2-phosphonobutane-1,2,4-tricarboxylic acid are also suitable. Glycinamide-N,N′-disuccinic acid (GADS), ethylenediamine-N-N′-diglutaric acid (EDDG) and 2-hydroxypropylenediamine-N-N′-disuccinic acid (HPDDS) are also suitable.

Especially preferred are diethylenetriamine pentacetic acid, ethylenediamine-N,N′-disuccinic acid (EDDS) and 1,1 hydroxyethane diphosphonic acid or the alkali metal, alkaline earth metal, ammonium, or substituted ammonium salts thereof, or mixtures thereof.

In particular the chelating agents comprising a amino or amine group can be bleach-sensitive and are suitable in the compositions of the invention.

Another highly preferred ingredient useful in the compositions herein is one or more additional enzymes.

Preferred additional enzymatic materials include the commercially available lipases, cutinases, amylases, neutral and alkaline proteases, cellulases, endolases, esterases, pectinases, lactases and peroxidases conventionally incorporated into detergent compositions. Suitable enzymes are discussed in U.S. Pat. Nos. 3,519,570 and 3,533,139.

Preferred commercially available protease enzymes include those sold under the tradenames Alcalase, Savinase, Primase, Durazym, and Esperase by Novo Industries A/S (Denmark), those sold under the tradename Maxatase, Maxacal and Maxapem by Gist-Brocades, those sold by Genencor International, and those sold under the tradename Opticlean and Optimase by Solvay Enzymes. Protease enzyme may be incorporated into the compositions in accordance with the invention at a level of from 0.0001% to 4% active enzyme by weight of the composition.

Preferred amylases include, for example, α-amylases obtained from a special strain of B licheniformis, described in more detail in GB-1,269,839 (Novo). Preferred commercially available amylases include for example, those sold under the tradename Rapidase by Gist-Brocades, and those sold under the tradename Termamyl, Duramyl and BAN by Novo Industries A/S. Highly preferred amylase enzymes maybe those described in PCT/US 9703635, and in WO95/26397 and WO96/23873.

Amylase enzyme may be incorporated into the composition in accordance with the invention at a level of from 0.0001% to 2% active enzyme by weight.

Lipolytic enzyme may be present at levels of active lipolytic enzyme of from 0.0001% to 2% by weight, preferably 0.001% to 1% by weight, most preferably from 0.001% to 0.5% by weight.

The lipase may be fungal or bacterial in origin being obtained, for example, from a lipase producing strain of Humicola sp., Thermomyces sp. or Pseudomonas sp. including Pseudomonas pseudoalcaligenes or Pseudomas fluorescens. Lipase from chemically or genetically modified mutants of these strains are also useful herein. A preferred lipase is derived from Pseudomonas pseudoalcaligenes, which is described in Granted European Patent, EP-B-0218272.

Another preferred lipase herein is obtained by cloning the gene from Humicola lanuginosa and expressing the gene in Aspergillus oryza, as host, as described in European Patent Application, EP-A-0258 068, which is commercially available from Novo Industri A/S, Bagsvaerd, Denmark, under the trade name Lipolase. This lipase is also described in U.S. Pat. No. 4,810,414, Huge-Jensen et al, issued Mar. 7, 1989.

The phosphate-containing builder material preferably comprises tetrasodium pyrophosphate or even more preferably anhydrous sodium tripolyphosphate.

Also preferred herein are builders, such as water-soluble and water-insoluble builders. Preferred water-insoluble builders, typically for solid compositions herein are alumino silicates such as zeolites (zeolite A, MAP, P, X) and layered silicates such as known as SKS-6, sold by Clariant.

Suitable water-soluble builder compounds include the water soluble monomeric polycarboxylates, or their acid forms, homo or copolymeric polycarboxylic acids or their salts in which the polycarboxylic acid comprises at least two carboxylic radicals separated from each other by not more that two carbon atoms, and mixtures of any of the foregoing.

The carboxylate or polycarboxylate builder can be momomeric or oligomeric in type although monomeric polycarboxylates are generally preferred for reasons of cost and performance.

Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates or their acids containing three carboxy groups include, in particular, water-soluble citrates, aconitrates and citraconates as well as succinate derivatives such as the carboxymethyloxysuccinates described in British Patent No. 1,379,241, lactoxysuccinates described in British Patent No. 1,389,732, and aminosuccinates described in Netherlands Application 7205873, and the oxypolycarboxylate materials such as 2-oxa-1,1,3-propane tricarboxylates described in British Patent No. 1,387,447. The most preferred polycarboxylic acid containing three carboxy groups is citric acid, preferably present at a level of from 0.1 % to 15%, more preferably from 0.5% to 8% by weight.

Polycarboxylates containing four carboxy groups include oxydisuccinates disclosed in British Patent No. 1,261,829, 1,1,2,2-ethane tetracarboxylates, 1,1,3,3-propane tetracarboxylates and 1,1,2,3-propane tetracarboxylates. Polycarboxylates containing sulfo substituents include the sulfosuccinate derivatives disclosed in British Patent Nos. 1,398,421 and 1,398,422 and in U.S. Pat. No. 3,936,448, and the sulfonated pyrolysed citrates described in British Patent No. 1,439,000. Preferred polycarboxylates are hydroxycarboxylates containing up to three carboxy groups per molecule, more particularly citrates.

The parent acids of the monomeric or oligomeric polycarboxylate chelating agents or mixtures thereof with their salts, e.g. citric acid or citrate/citric acid mixtures are also contemplated as useful builder components.

Suitable examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerization ranges from about 6 to 21, and salts of phytic acid.

Also preferred in compositions hererin are fabric integrity polymers such as cyclic amine based polymers, including adducts of two or more compositions selected from the group consisting of piperazine, piperadine, epichlorohydrin, epichlorohydrin benzyl quat, epichlorohydrin methyl quat, morpholine and mixtures thereof.

Highly preferred cyclic amine based polymers herein are referred to as Imidazole-epi chlorohydrin copolymers. These cyclic amine based polymers can be linear or branched. One specific type of branching can be introduced using a polyfunctional crosslinking agent. An example of such polymer is exemplified below.

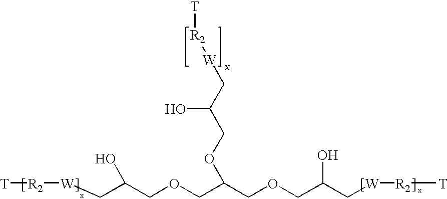

This material will generally be about 0.01% to about 10% by the weight of the detergent composition or component, more preferably from 0.05% to 6% or even from 0.05% to 3%.

The compositions herein may also comprise as soil release or fabric integrity agents, salt of an anionic cellulose material comprising an anionic substituent group R—X—Z wherein R is a saturated, unsaturated or aromatic hydrocarbon spacer group, X is oxygen, nitrogen or sulphur, Z is carboxylate, sulphonate, sulphate or phosphonate group. The hydrocarbon spacer group is preferably a C₁-C₁₈, more preferably a C₁-C₁₄, or even more preferably a C₁-C₄ saturated, unsaturated or aromatic group, preferably an alkylene group. The spacer group may also be substituted with one or more hydroxy groups. he group X is preferably a nitrogen, or even more preferably an oxygen atom. The group Z is preferably a carboxylate group. Highly preferred hereon are the so-called salts of carboxyalkyl celluloses, whereby preferably the alkylene group (or the so-called alkyl group) comprises from 1 to 4 carbon atoms. Most preferred herein is a salt of carboxymethyl cellulose. The cation of the salt is preferably a potassium ion or more preferably a sodium ion.

Depending on the application of the composition, the amount of cellulose material may very. The anionic cellulose material will generally be about 0.01% to about 10% by the weight of the detergent composition or component, more preferably from 0.05% to 6% or even from 0.05% to 3% by weight of a composition.

The softening ingredients useful herein may be selected from any known ingredients that provides a fabric softening benefit.

Clay minerals used to provide the softening properties. Smectites, such as montmorillonite and bentonite, having an ion exchange capacity of around 70 meq/100 g., and montmorillonite, which has an ion exchange capacity greater than 70 meq/100 g., have been found to be useful in the compositions herei in that they are deposited on the fabrics to provide the desired softening benefits. Accordingly, clay minerals useful herein can be characterized as expandable, three-layer smectite-type clays having an ion exchange capacity of at least about 50 meq/100 g.

The smectite clays used in the compositions herein are all commercially available. Such clays include, for example, montmorillonite, volchonskoite, nontronite, hectorite, saponite, sauconite, and vermiculite. The clays herein are available under various tradenames, for example, Thixogel #1® and Gelwhite GP® from Georgia Kaolin Co., Elizabeth, N.J.; Volclay BC® and Volclay #325®, from American Colloid Co., Skokie, Ill.; Black Hills Bentonite BH450®, from International Minerals and Chemicals; and Veegum Pro and Veegum F, from R. T. Vanderbilt. It is to be recognised that such smectite-type minerals obtained under the foregoing tradenames can comprise mixtures of the various discrete mineral entities. Such mixtures of the smectite minerals are suitable for use herein.

While any of the smectite-type clays having a cation exchange capacity of at least about 50 meq/100 g. are useful herein, certain clays are preferred. For example, Gelwhite GP® is an extremely white form of smectite clay and is therefore preferred when formulating white granular detergent compositions.

Other suitable softening ingredients are long chained polymers and copolymers derived from such monomers as ethylene oxide, acrylamide, acrylic acid, dimethylamino ethyl methacrylate, vinyl alcohol, vinyl pyrrolidone and ethylene imide. Preferred are polymers of ethylene oxide, acrylamide and acrylic acid. These polymers preferably have average molecular weight in the range of from 100 000 to 10 million, more preferably from 150 000 to 5 million. Average molecular weight of a polymer can be easily measured using gel permeation chromatography, against standards of polyethylene oxide of narrow molecular weight distributions. The most preferred polymers are polyethylene oxides.

Other suitable softening ingredients include cationic fabric softening agents can also be incorporated into compositions in accordance with the present invention which are suitable for use in methods of laundry washing. Suitable cationic fabric softening agents include the water insoluble tertiary amines or dilong chain amide materials as disclosed in GB-A-1 514 276 and EP-B-0 011 340.

Other preferred ingredients are neutralizing agents, buffering agents, including (bi) carbonate salts, phase regulants, hydrotropes, enzyme stabilizing agents, polyacids, suds regulants, anti-oxidants, bactericides, or mixtures thereof.

### EXAMPLES

### Example

A sheet of pouches is made in by using a horizontal molding table having a series of 3×4 molds of a hollow, round shape. The molds have some holes in the bottom to allow a vacuum to be applied. A piece of (optionally heated) Chris-Craft M-8630 or CXP4087 film is placed on top of these molds. A vacuum is applied to pull the film into the molds and pull the film flush with the inner surface of the mold. A composition, for example as exemplified below, is poured into the mold, preferably in an amount to almost or completely fill the mold. Then, another piece of the same film material is placed over the mold and sealed to the first piece of film by applying heat.

This is repeated 3 more times and the 4 sheets are placed in a carton box with an opening and closable top lid.

This process can be modified by using other methods of forming the shape of the pouches, other types of film, other number of sizes of molds, sealing methods, more individual pouches etc.

Abbreviations used in Examples

In the detergent compositions, the abbreviated component identifications have the following meanings:

| | |
|---|---|
| LAS | Sodium linear C₁₁₋₁₃ alkyl benzene sulfonate |
| HSAS | C₁₁₋₁₃ alkyl benzene sulfonic acid |
| TAS | Sodium tallow alkyl sulphate |
| CxyAS | Sodium C₁ₓ-C_{1y} alkyl sulphate |
| CxyASz | Sodium C₁ₓ-C_{1y} alkyl sulphate, having a weight |
| | average branching degree of at least z |
| QAS | R₂.N⁺(CH₃)₂(C₂H₄OH) with R₂ = C₁₂-C₁₄ |
| MBAS | Branched C16-C18 alkylsulphate having an average methyl |
| | branching of 1.5 |
| APA | C₈-C₁₀ amido propyl dimethyl amine |
| Soap | Sodium linear alkyl carboxylate derived from an 80/20 |
| | mixture of tallow and coconut fatty acids |
| TPKFA | C₁₆-C₁₈ topped whole cut fatty acids |
| Citric acid | Anhydrous citric acid |
| Citrate | Tri-sodium citrate dihydrate of activity 86.4% with a particle |
| | size distribution between 425 μm and 850 μm |
| MA/AA | Copolymer of 1:4 maleic/acrylic acid, average molecular |
| | weight about 70,000 |
| Cellulose | Methyl cellulose ether with a degree of polymerization of 650 |
| ether | available from Shin Etsu Chemicals |
| EA I | Ethoxylated tetraethylene pentaimine having at least 5 |
| | ethoxylation groups, each having an average ethoxylation |
| | degree of 15-25. |
| EA II | Ethoxylated imine having at least 10 ethoxylated amine |
| | groups, each having an average ethoxylation degree of 15-25. |
| Protease | Proteolytic enzyme, having 3.3% by weight of active enzyme, |
| | sold by NOVO Industries A/S under the tradename Savinase |
| Cellulase | Cellulytic enzyme, having 0.23% by weight of active enzyme, |
| | sold by NOVO Industries A/S under the tradename Carezyme |
| Amylase | Amylolytic enzyme, having 1.6% by weight of active enzyme, |
| | sold by NOVO Industries A/S under the tradename Termamyl |
| | 120T |
| Lipase | Lipolytic enzyme, having 2.0% by weight of active enzyme, |
| | sold by NOVO Industries A/S under the tradename Lipolase |
| | or Lipolase Ultra |
| | Sodium percarbonate of nominal formula 2Na₂CO₃.3H₂O₂ |
| EDDS | Ethylenediamine-N,N′-disuccinic acid, (S,S) isomer in the |
| | form of its sodium salt. |
| HEDP | 1,1-hydroxyethane diphosphonic acid |
| Photo- | Sulfonated zinc phthlocyanine encapsulated in dextrin soluble |
| activated | polymer |
| bleach | |
| Brightener | Disodium 4,4′-bis(2-sulphostyryl)biphenyl or |
| | Disodium 4,4′-bis(4-anilino-6-morpholino-1.3.5-triazin-2- |
| | yl)amino) stilbene-2:2′-disulfonate |
| PVNO | Polyvinylpyridine N-oxide polymer, with an average |
| | molecular weight of 50,000 |
| PVPVI | Copolymer of polyvinylpyrolidone and vinylimidazole, with |
| | an average molecular weight of 20,000 |
| Clay | Bentone SD-3, as available from Rheox/Elementis, and/or |
| | Bentone EW, as available from Rheox/Elementis |
| Opacifier | |

In the following examples all levels are quoted as % by weight of the composition:

### Example 1

The following liquid composition is in accord with the invention

| Component | A | B | C |
|---|---|---|---|
| C₂₃AS90 and/or C25AS60 | 14.0 | 20.0 | 5.0 |
| LAS | 6.0 | — | 9.0 |
| Citric Acid | 2.0 | 1.5 | 3.0 |
| C₁₂₋₁₈ Fatty Acid (s) | 16.0 | 12.0 | 18.0 |
| Enzymes | 1.3 | 1.0 | 0.5 |
| QAS | 1.0 | 1.0 | — |
| Propanediol | 2.3 | — | — |
| Boric acid | 2.0 | 2.0 | — |
| Dispersant | 1.4 | — | 1.0 |
| HEDP or EDDS | 0.5 | 0.25 | 1.25 |
| Clay I | 1.0 | 0.5 | 0.5 |
| Clay III | 4.0 | 6.5 | 4.0 |
| Clay IV | — | — | 4.0 |
| Dye, Perfume, Brighteners, Preservatives, | Balance | Balance | Balance |
| Suds Suppressor, Other Minors, water | | | |
| | 100% | 100% | 100% |

### Example 2

The following liquid detergent formulations are prepared according to the present invention

| | | A | B | C | D |
|---|---|---|---|---|---|
| LAS | | 17.5 | 9.0 | — | 4.0 |
| C25AS and/or C25AS80 | | — | 12.0 | 18.0 | 10.0 |
| MBAS | | — | — | — | 4.0 |
| QAS | | — | — | 1.0 | 1.0 |
| Rape seed oil fatty acid | | 7.5 | 3.5 | 14.0 | — |
| CFAA | | 4.0 | — | — | — |
| TPKFA | | — | 7.5 | 2.0 | 9.5 |
| Citric acid | | 6.5 | 1.0 | 2.5 | 4.0 |
| encapsulated perfume | | 0.1 | 1.0 | 2.0 | — |
| Na formate or acetate | | 0.5 | — | — | 0.5 |
| STS | | — | 1.0 | — | 1.2 |
| Borate/boric acid | | 0.6 | 2.0 | 3.0 | 2.0 |
| Na hydroxide | | 1.0 | 2.0 | — | 1.0 |
| Ethanol | | 2.0 | 1.0 | — | — |
| 1,2 Propanediol | | 3.0 | 2.0 | — | — |
| Clay II | | 0.5 | 1.5 | 1.0 | 0.5 |
| Clay III | | 7.0 | 4.0 | 6.5 | 8.0 |
| Clay IV | | — | 1.0 | 2.0 | — |
| Protease | | — | 0.3 | 1.0 | 0.5 |
| Lipase | | — | — | 0.2 | — |
| Amylase | | — | — | — | 0.2 |
| Cellulase | | — | — | 0.2 | 0.5 |
| PVNO | | — | — | 0.3 | — |
| Brightener 1 | | 0.2 | 0.07 | 0.1 | — |
| Water | balance: | | | | |

### Example 3

The following liquid detergent formulations are according to the present invention

| | A | B | C | D | E | F | G |
|---|---|---|---|---|---|---|---|
| LAS | 10.0 | 80 | 9.0 | — | 25.0 | — | — |
| C25AS60 | 4.0 | 30 | 11. | 8.0 | — | 13.0 | 18.0 |
| C25A90 | 60 | 3.0 | — | 4. | — | 6. | — |
| C25AS | | 8.0 | — | 8.0 | — | — | — |
| rape seed oil fatty acid | 3.5 | 3.0 | — | 4.5 | 3.0 | 4.0 | 8.0 |
| APA | — | 1.4 | — | — | — | 1.0 | — |
| TPKFA | 2. | — | 13.0 | 7.0 | 14.0 | 15.0 | — |
| Citric | 2.0 | 3.0 | 1.0 | 1.5 | 1.0 | 1.0 | 1.0 |
| Dodecenyl/ | 4.0 | | — | — | — | — | — |
| tetradecenyl | | | | | | | |
| succinic acid | | | | | | | |
| Ethanol | 4.0 | | | 2.0 | | 2.0 | |
| 1,2 Propanediol | | 4.0 | 2.0 | | 6.0 | | |
| Monoethanolamine | — | — | — | 5.0 | — | — | |
| CMC | 0.2 | | 0.5 | 0.7 | 2.0 | 1.2 | |
| Clay I and III | 6.0 | 5.5 | 7.5 | 9.0 | 5.0 | 8.5 | 13.0 |
| DETPMP | 1.0 | 1.0 | 0.5 | 1.0 | | | |
| Protease | 0.2 | 1.0 | 0.9 | 0.6 | — | 0.5 | |
| Lipase | — | | — | | | 0.3 | 0.3 |
| Amylase | 0.4 | 0. | 0.3 | 0.5 | — | — | 0.4 |
| Cellulase | — | — | — | — | — | — | 0.2 |
| Boric acid | 0.1 | 0.2 | 1.0 | 2.0 | 4.0 | 4.0 | — |
| Ca chloride | — | 0.02 | — | 0.01 | 0.1 | 0.2 | 0.3 |
| Brightener 1 | — | 0.4 | — | — | 0.4 | — | — |
| Suds suppressor | | 0.3 | — | 0.1 | 0.8 | 0.7 | — |
| Opacifier | 0.5 | 0.4 | — | 0.3 | 8.0 | 7.5 | 8.0 |
| NaOH up to pH 8 | 8.0 | 8.0 | | | | | |
| water up to balance | | | | | | | |

What is claimed is:

1. A container comprising one or more sheets of water-soluble pouches, the pouches comprising a composition to be delivered to water.

2. A container comprising one or more sheets of pouches according to claim 1 whereby the composition in the pouches is a cleaning composition or fabric care composition.

3. A container comprising one or more sheets of pouches according to claim 1 whereby said sheet or sheets of pouches is obtainable by a process comprising the steps of:
forming from a water-soluble film, a series of open pouches, filling the pouches with a composition and closing the pouches, placing said film over a series of mold, shaping the film into a series of open pouches in said molds, filling the pouches with the composition and closing the open pouches.

4. A container comprising one or more sheets of pouches according to claim 1 whereby the sheet or sheets comprises visible lines of weakness around the pouches or part thereof.

5. A container comprising a sheet of pouches according to claim 1 whereby the sheet is water-soluble, and/or whereby the sheet and pouches are made of a film of a water-soluble polymer comprising polyvinyl alcohol or derivative thereof.

6. A container comprising a sheet of pouches according to claim 1 whereby at least a part of each pouch has a thickness of less than 80 microns.

7. A container comprising one or more sheets of pouches according to claim 1 whereby the pouches have at least a compartment comprising a liquid composition.

8. A container comprising one or more sheet of pouches according to claim 1 whereby the pouches have at least a compartment made of a water-soluble film having an area of weakness.

9. A container comprising one or more sheets of pouches according to claim 1 whereby the pouches are made of a stretched film material.

10. A container as in claim 1 being rigid.

11. A container according to claim 10 whereby the rigid container comprises inside the container a bag, the sheet or sheets of pouches being inside said bag.

12. A container according to claim 1 having a reclosable sealing means.

13. A process for obtaining a container according to claim 1 comprising the step of making one or more sheets of pouches and making visible lines, of weakness around the pouches or part thereof, and then placing one or more of the sheets in a container.

14. A process for obtaining a container according to claim 1 comprising the steps of placing a film over a series of mold, shaping the film into a series of open pouches in said molds, filling the pouches with the composition, closing the open pouches, applying visible lines of weakness around the pouches or part thereof and placing one or more of the obtained sheet in a container.

15. Method of packing water-soluble pouches in a container by providing the pouches in the form of a sheet comprising said pouches, the sheet and the pouches being of the same material, the sheet having visible lines of weakness around one or more of the pouches.
